(19) United States
(12) Patent Application Publication
(10) Pub. No.: US 2025/0360578 A1
(43) Pub. Date: Nov. 27, 2025

(54) WAFER FLATTENING SYSTEM AND METHOD THEREOF

(71) Applicant: NANYA TECHNOLOGY CORPORATION, New Taipei city (TW)

(72) Inventor: Yu-Chen HUANG, New Taipei City (TW)

(21) Appl. No.: 18/673,808

(22) Filed: May 24, 2024

(51) Int. Cl. B23K 26/352; B23K 26/03; B23K 26/062; B23K 37/047; B23K 101/40

(52) U.S. Cl. CPC B23K 26/352; B23K 26/03; B23K 26/062; B23K 37/047; B23K 2101/40

(57) ABSTRACT

A wafer flattening system includes a curvature measurement device, a laser generator and a controlling unit. The curvature measurement device is configured to obtain a curvature of a wafer. The wafer has an upper surface and a lower surface opposite to the upper surface. The upper surface defines the curvature. The lower surface is disposed with a stress adjustment film. The laser generator is configured to emit a laser beam. The controlling unit is signally connected with the curvature measurement device and the laser generator. The controlling unit is configured to control the laser generator to emit the laser beam to anneal locally the stress adjustment film according to the curvature measured in order to reduce the curvature.

### BACKGROUND

### Technical Field

The present disclosure relates to wafer flattening systems and the method of flattening a wafer using these wafer flattening systems.

### Description of Related Art

As the demand for electronic devices has been increasing nowadays, the quality of various components of electronic devices becomes an important issue of the industry. Apart from improving the manufacturing technology of the components, the measures to guarantee the quality of the components during production is also highly concerned.

For example, in order to increase the yield rate of wafers and thus decrease the cost of production, the maintenance of wafers in a flat status throughout the process of production is undoubtedly an important key in the industry.

### SUMMARY

A technical aspect of the present disclosure is to provide a wafer flattening system, which can make a curved wafer to become flat in a simple and accurate manner.

According to an embodiment of the present disclosure, a wafer flattening system includes a curvature measurement device, a laser generator and a controlling unit. The curvature measurement device is configured to obtain a curvature of a wafer. The wafer has an upper surface and a lower surface opposite to the upper surface. The upper surface defines the curvature. The lower surface is disposed with a stress adjustment film. The laser generator is configured to emit a laser beam. The controlling unit is signally connected with the curvature measurement device and the laser generator. The controlling unit is configured to control the laser generator to emit the laser beam to anneal locally the stress adjustment film according to the curvature measured in order to reduce the curvature.

In one or more embodiments of the present disclosure, the curvature measurement device is configured to define a plurality of coordinates on the upper surface and measure a relative height at each of the coordinates. The controlling unit is further configured to spot a location on the stress adjustment film corresponding to one of the coordinates. The laser generator is configured to emit the laser beam to the location spotted.

In one or more embodiments of the present disclosure, the controlling unit is further configured to adjust at least one of a magnitude and a duration of the laser beam.

In one or more embodiments of the present disclosure, the wafer flattening system further includes a moving unit. The moving unit is signally connected with the controlling unit. The moving unit is configured to turn the wafer, such that the upper surface and the lower surface are exchanged in position.

A technical aspect of the present disclosure is to provide a wafer flattening method, which can make a curved wafer to become flat in a simple and accurate manner.

According to an embodiment of the present disclosure, a wafer flattening method includes: providing a wafer having an upper surface and a lower surface opposite to the upper surface; forming a stress adjustment film on the lower surface; defining a plurality of coordinates on the upper surface; obtaining a first curvature of the upper surface by measuring a first relative height at each of the coordinates; and increasing a temperature of the stress adjustment film locally according to the first relative heights measured in order to reduce the first curvature.

In one or more embodiments of the present disclosure, the step of increasing the temperature includes: emitting a laser beam to the stress adjustment film.

In one or more embodiments of the present disclosure, the step of emitting the laser beam includes: adjusting at least one of a magnitude and a duration of the laser beam.

In one or more embodiments of the present disclosure, the step of emitting the laser beam includes: spotting a location on the stress adjustment film corresponding to one of the coordinates.

In one or more embodiments of the present disclosure, the step of increasing the temperature includes: annealing the stress adjustment film.

In one or more embodiments of the present disclosure, the stress adjustment film is amorphous.

In one or more embodiments of the present disclosure, the method further includes: turning the wafer such that the upper surface and the lower surface are exchanged in position.

In one or more embodiments of the present disclosure, the method further includes: obtaining a second curvature of the upper surface reduced from the first curvature by measuring a second relative height at each of the coordinates.

According to an embodiment of the present disclosure, a wafer flattening method includes: providing a wafer having an upper surface and a lower surface opposite to the upper surface; forming a stress adjustment film on the lower surface; defining a plurality of coordinates on the upper surface; obtaining a first curvature of the upper surface by measuring a first relative height at each of the coordinates; and annealing the stress adjustment film locally by a laser beam according to the first relative heights measured in order to flatten the upper surface.

In one or more embodiments of the present disclosure, the step of annealing the stress adjustment film includes: spotting a location on the stress adjustment film corresponding to one of the coordinates.

In one or more embodiments of the present disclosure, the step of annealing the stress adjustment film includes: adjusting at least one of a magnitude and a duration of the laser beam.

In one or more embodiments of the present disclosure, the stress adjustment film is amorphous.

In one or more embodiments of the present disclosure, the method further includes: turning the wafer such that the upper surface and the lower surface are exchanged in position.

In one or more embodiments of the present disclosure, the method further includes: obtaining a second curvature of the upper surface reduced from the first curvature by measuring a second relative height at each of the coordinates.

The above-mentioned embodiments of the present disclosure have at least the following advantages: a curved wafer can be made flat in a simple and accurate manner.

### BRIEF DESCRIPTION OF THE DRAWINGS

The disclosure can be more fully understood by reading the following detailed description of the embodiments, with reference made to the accompanying drawings as follows:

FIG. 1 is a flow chart of a wafer flattening method according to an embodiment of the present disclosure; and

FIGS. 2-4 are front views of a wafer flattening system, throughout a process of flattening a wafer, according to an embodiment of the present disclosure.

### DETAILED DESCRIPTION

Drawings will be used below to disclose embodiments of the present disclosure. For the sake of clear illustration, many practical details will be explained together in the description below. However, it is appreciated that the practical details should not be used to limit the claimed scope. In other words, in some embodiments of the present disclosure, the practical details are not essential. Moreover, for the sake of drawing simplification, some customary structures and elements in the drawings will be schematically shown in a simplified way. Wherever possible, the same reference numbers are used in the drawings and the description to refer to the same or like parts.

Unless otherwise defined, all terms (including technical and scientific terms) used herein have the same meanings as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

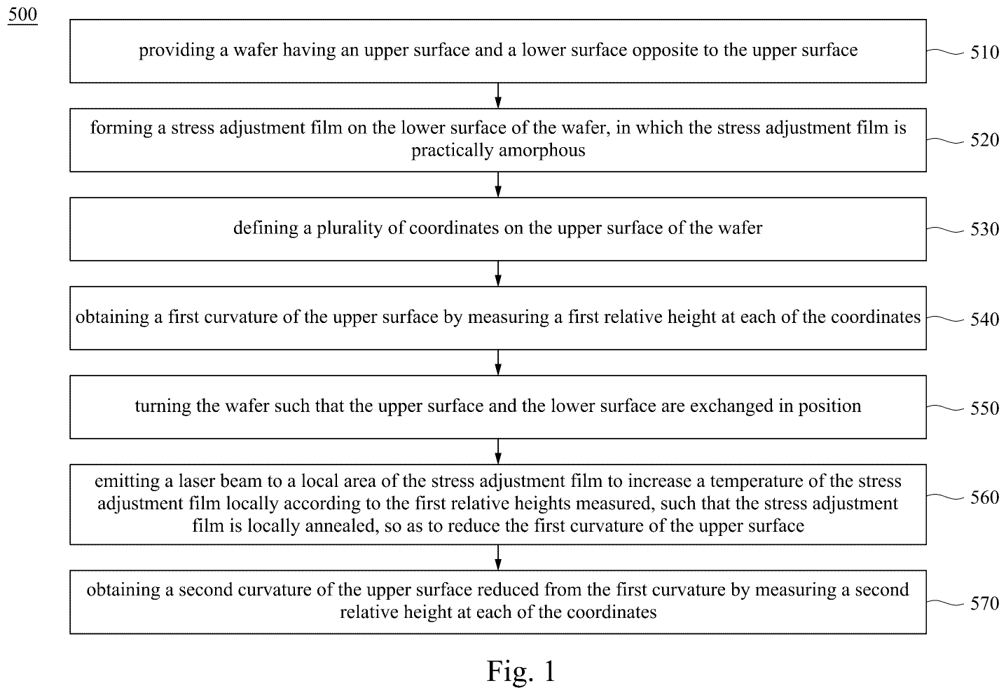

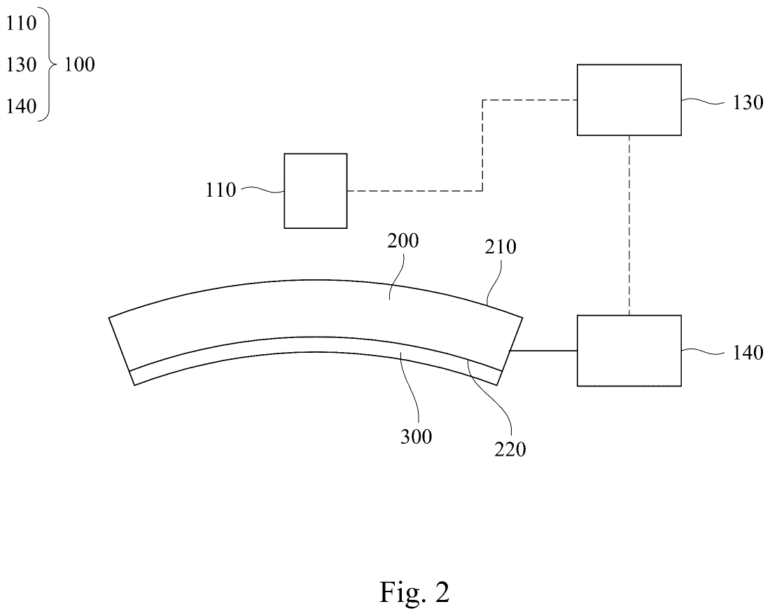

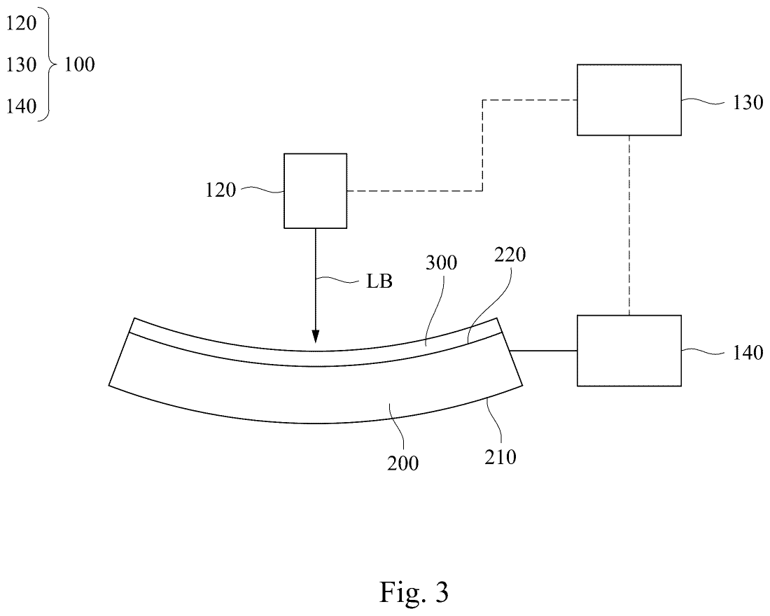

Reference is made to FIG. 1. FIG. 1 is a flow chart of a wafer flattening method 500 according to an embodiment of the present disclosure. In this embodiment, as shown in FIG. 1, the wafer flattening method 500 includes the following procedures, which should be understood that the order of procedures mentioned below can be changed as per actual requirements, and some of the procedures may be executed simultaneously or partially simultaneously unless their sequence is explicitly stated:
Procedure 510: providing a wafer 200 having an upper surface 210 and a lower surface 220 opposite to the upper surface 210.
Procedure 520: forming a stress adjustment film 300 on the lower surface 220 of the wafer 200, in which the stress adjustment film 300 is practically amorphous.
Procedure 530: defining a plurality of coordinates on the upper surface 210 of the wafer 200. Please refer to FIG. 2. In this embodiment, a wafer flattening system 100 is provided. As shown in FIG. 2, the wafer flattening system 100 further includes a curvature measurement device 110 and a controlling unit 130. The curvature measurement device 110 is signally connected with the controlling unit 130 and configured to define a plurality of coordinates, such as x and y coordinates, on the upper surface 210 of the wafer 200.
Procedure 540: obtaining a first curvature of the upper surface 210 by measuring a first relative height at each of the coordinates. Furthermore, the curvature measurement device 110 is configured to measure a first relative height at each of the coordinates. In this way, a first curvature defined by the upper surface 210 of the wafer 200 is obtained by the curvature measurement device 110. In practice, the first curvature may be of a concave form or a convex form. Moreover, according to the actual situations, the wafer 200 may have a plurality of first curvatures on the upper surface 210 and each of the first curvatures may be of a concave form or a convex form. For example, as shown in FIG. 2, the first curvature of the upper surface 210 is of a convex form, which is presented in an exaggerated manner for easy understanding.
Procedure 550: turning the wafer 200 such that the upper surface 210 and the lower surface 220 are exchanged in position. As shown in FIGS. 2-3, the wafer flattening system 100 further includes a moving unit 140. The moving unit 140 is signally connected with the controlling unit 130 and mechanically connected with the wafer 200. The moving unit 140 is controlled by the controlling unit 130 to turn the wafer 200, such that the upper surface 210 and the lower surface 220 of the wafer 200 are exchanged in position. As shown in FIG. 3, the wafer 200 is already turned by the moving unit 140, such that the upper surface 210 and the lower surface 220 are exchanged in position. For the sake of drawing simplification, the curvature measurement device 110 is not shown in FIG. 3.
Procedure 560: emitting a laser beam LB to a local area of the stress adjustment film 300 to increase a temperature of the stress adjustment film 300 locally according to the first relative heights measured, such that the stress adjustment film 300 is locally annealed, so as to reduce the first curvature of the upper surface 210. As shown in FIG. 3, the wafer flattening system 100 further includes a laser generator 120. The laser generator 120 is signally connected with the controlling unit 130 and is configured to emit a laser beam LB. To be specific, the controlling unit 130 is configured to control the laser generator 120 to emit the laser beam LB to anneal locally the stress adjustment film 300 according to the curvature measured in order to flatten the wafer 200 by reducing the curvature. For the sake of drawing simplification, the laser generator 120 is not shown in FIG. 2.

Furthermore, in practical applications, the controlling unit 130 is further configured to spot a location on the stress adjustment film 300 corresponding to one of the coordinates, and the laser generator 120 is configured to emit the laser beam LB to the location spotted.

In details, when the laser beam LB reaches the location spotted on the stress adjustment film 300, the stress adjustment film 300, which is amorphous as mentioned above, is locally transformed into a crystal structure. The stress induced by the mismatch of lattice constants of the stress adjustment film 300 with the wafer 200 then changes the shape of the wafer 200, causing the first curvature of the upper surface 210 to be reduced and the wafer 200 to be then flatten. For a better effect of local transformation of the stress adjustment film 300 into a crystal structure, the controlling unit 130 is further configured to adjust at least one of a magnitude and a duration of the laser beam LB, according to the actual situations.

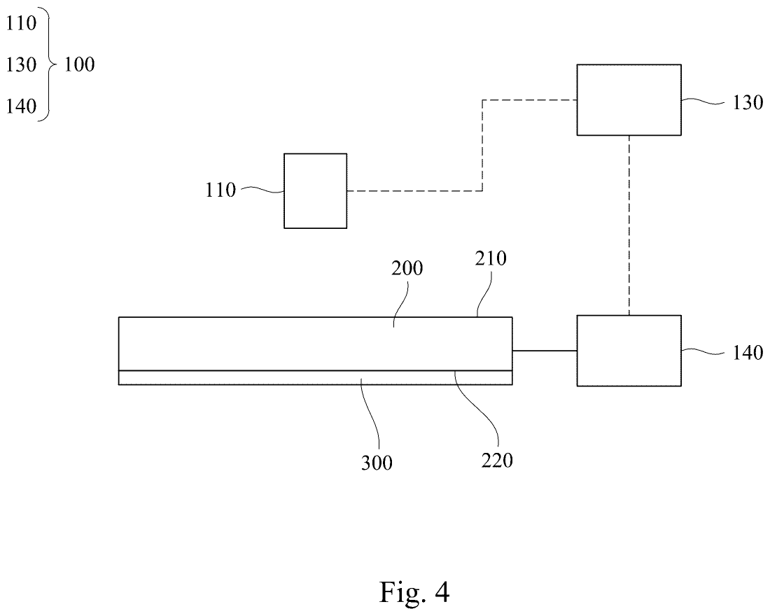

Procedure 570: obtaining a second curvature of the upper surface 210 reduced from the first curvature by measuring a second relative height at each of the coordinates. As shown in FIG. 4, the curvature measurement device 110 is further configured to measure a second relative height at each of the coordinates. In this way, a second curvature defined by the upper surface 210 of the wafer 200 and reduced from the first curvature after the Procedure 560 above is obtained. For the sake of drawing simplification, the laser generator 120 is not shown in FIG. 4.

At this point, if the second curvature of the upper surface 210 is still not acceptable, the process is then repeated from Procedure 550 until the upper surface 210 of the wafer 200 is flattened to a predetermined standard. By the application of the wafer flattening system 100, a curved wafer 200 can be made flat in a simple and accurate manner, which facilitates the subsequent manufacturing process of the wafer 200 in the exposure, for example.

In conclusion, the aforementioned embodiments of the present disclosure have at least the following advantages: a curved wafer can be made flat in a simple and accurate manner.

Although the present disclosure has been described in considerable detail with reference to certain embodiments thereof, other embodiments are possible. Therefore, the spirit and scope of the appended claims should not be limited to the description of the embodiments contained herein.

It will be apparent to the person having ordinary skill in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

What is claimed is:

1. A wafer flattening system, comprising:
a curvature measurement device configured to obtain a curvature of a wafer, the wafer having an upper surface and a lower surface opposite to the upper surface, the upper surface defining the curvature, the lower surface being disposed with a stress adjustment film;
a laser generator configured to emit a laser beam; and
a controlling unit signally connected with the curvature measurement device and the laser generator, the controlling unit being configured to control the laser generator to emit the laser beam to anneal locally the stress adjustment film according to the curvature measured in order to reduce the curvature.

2. The wafer flattening system of claim 1, wherein the curvature measurement device is configured to define a plurality of coordinates on the upper surface and measure a relative height at each of the coordinates, the controlling unit is further configured to spot a location on the stress adjustment film corresponding to one of the coordinates, the laser generator is configured to emit the laser beam to the location spotted.

3. The wafer flattening system of claim 1, wherein the controlling unit is further configured to adjust at least one of a magnitude and a duration of the laser beam.

4. The wafer flattening system of claim 1, further comprising:
a moving unit signally connected with the controlling unit and configured to turn the wafer, such that the upper surface and the lower surface are exchanged in position.

5. A wafer flattening method, comprising:
providing a wafer having an upper surface and a lower surface opposite to the upper surface;
forming a stress adjustment film on the lower surface;
defining a plurality of coordinates on the upper surface;
obtaining a first curvature of the upper surface by measuring a first relative height at each of the coordinates; and
increasing a temperature of the stress adjustment film locally according to the first relative heights measured in order to reduce the first curvature.

6. The method of claim 5, wherein increasing the temperature comprises:
emitting a laser beam to the stress adjustment film.

7. The method of claim 6, wherein emitting the laser beam comprises:
adjusting at least one of a magnitude and a duration of the laser beam.

8. The method of claim 6, wherein emitting the laser beam comprises:
spotting a location on the stress adjustment film corresponding to one of the coordinates.

9. The method of claim 5, wherein increasing the temperature comprises:
annealing the stress adjustment film.

10. The method of claim 5, wherein the stress adjustment film is amorphous.

11. The method of claim 5, further comprising:
turning the wafer such that the upper surface and the lower surface are exchanged in position.

12. The method of claim 5, further comprising:
obtaining a second curvature of the upper surface reduced from the first curvature by measuring a second relative height at each of the coordinates.

13. A wafer flattening method, comprising:
providing a wafer having an upper surface and a lower surface opposite to the upper surface;
forming a stress adjustment film on the lower surface;
defining a plurality of coordinates on the upper surface;
obtaining a first curvature of the upper surface by measuring a first relative height at each of the coordinates; and
annealing the stress adjustment film locally by a laser beam according to the first relative heights measured in order to flatten the upper surface.

14. The method of claim 13, wherein annealing the stress adjustment film comprises:
spotting a location on the stress adjustment film corresponding to one of the coordinates.

15. The method of claim 13, wherein annealing the stress adjustment film comprises:
adjusting at least one of a magnitude and a duration of the laser beam.

16. The method of claim 13, wherein the stress adjustment film is amorphous.

17. The method of claim 13, further comprising:
turning the wafer such that the upper surface and the lower surface are exchanged in position.

18. The method of claim 13, further comprising:
obtaining a second curvature of the upper surface reduced from the first curvature by measuring a second relative height at each of the coordinates.
